(19) United States
(12) Patent Application Publication
(10) Pub. No.: US 2002/0020731 A1
(43) Pub. Date: Feb. 21, 2002

(54) Stapler and stapler positioning member

(76) Inventor: Mikio Nagai, Tokyo (JP)

Correspondence Address: RABIN & CHAMPAGNE, P.C., 1101 14th Street, NW., Suite 500, Washington, DC, 20005, US

(21) Appl. No.: 09/879,922

(22) Filed: Jun. 14, 2001

(30) Foreign Application Priority Data
Jun. 27, 2000 (JP) 2000-192903

(51) Int. Cl. B25C 5/02

(52) U.S. Cl. 227/134; 227/151

(57) ABSTRACT

Step parts 30A, 30B are formed on both sides of a first member 20 attached to a base 1 of a stapler such that the member is free to slide, and the thickness of a binding object (for example, a bundle of paper) is determined by comparing with the height of steps 31A-33A, 31B-33B of the step parts 30A, 30B. Markings are made on the steps 31A-33A, 31B-33B corresponding to their height. A hollow part 42 is formed inside the first member 20.

### FIELD OF THE INVENTION

This invention relates to a stapler and a stapler positioning member used for document binding, etc.

### BACKGROUND OF THE INVENTION

In a stapler, an object (for example, a bundle of paper) is filed for example with a U-shaped staple, and the staple used must have a length according to the thickness of the bundle of paper.

For this reason, the user of the stapler needs to be aware of the thickness of the bundle of paper somewhat correctly before performing the binding operation.

### SUMMARY OF THE INVENTION

However, as there was no determining criterion for judging the thickness of the bundle of paper in the conventional stapler, it could not be said that the user of the stapler could correctly determine the thickness of the bundle of paper and select a suitable staple.

This invention was conceived in view of the above problems, and aims to provide a stapler and stapler positioning member having a construction such that the thickness of the bundle of paper can be easily determined.

In order to achieve above the objects the present invention provides a stapler provided with a positioning member in contact with a binding object which specifies the position of the binding object, comprising a step part on at least one side face of the positioning member, wherein it is possible to determine the height of the binding object by comparison of the height of each steps of this step part with the height of the binding object.

The present invention further provides a stapler positioning member in contact with a binding object which specifies the position of the binding object, comprising a step part on at least one side face, wherein it is possible to determine the height of the binding object by comparison of the height of each steps of this step part with the height of the binding object.

### BRIEF DESCRIPTION OF THE DRAWINGS

FIG. 1 is a perspective view showing the overall construction of one embodiment of this invention.

FIG. 2 is a plan view showing a base.

FIG. 3 is a cross-sectional view showing a base and a positioning member.

FIG. 4 is a front view showing the positioning member.

FIG. 5 is a plan view showing the positioning member.

FIG. 6 is a base plan view also showing the positioning member.

### DESCRIPTION OF THE PREFERRED EMBODIMENTS

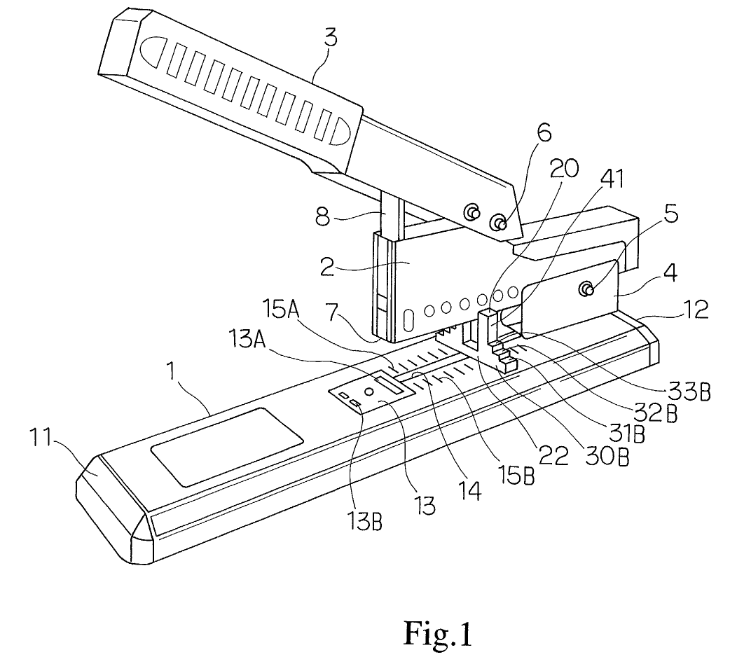

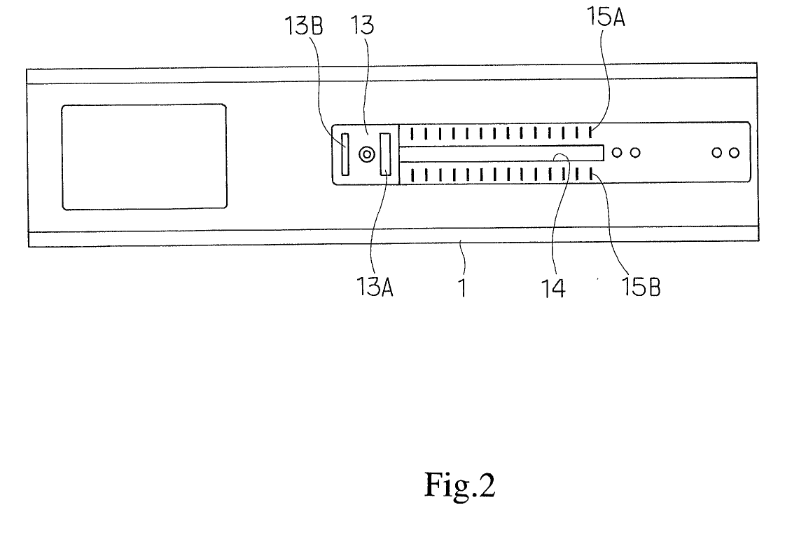

FIG. 1 shows the overall construction of the stapler. The base 1 of the stapler is shown in FIG. 2.

The stapler comprises a base 1, a staple case 2 and a handle 3 etc., as shown in the figure.

The staple case 2 is attached free to rotate via a shaft 5 to a frame 4 fixed to the rear end side (right-hand side of FIG. 1 and FIG. 2) of the base 1.The handle 3 is attached free to rotate via a shaft 6 to this staple case 2. Due to this construction, if the user of the stapler pushes the handle 3 downwards, the staple case 2 rotates downwards, and a staple stamping part 7 is pushed against a binding object (for example, bundle of paper) installed on the base 1. A cutting edge 8 coordinated with the handle 3 stamps out the staple held in the staple case 2 from the staple stamping plate 7, and the bundle of paper is filed with the staple.

The base 1 is a lengthwise member which comprises the lowermost part of the stapler, the stapler being installed in a usage position (for example, on a table) in this base 1. Rubber slip stop members 11, 12 are attached at both ends in the longitudinal direction of the base 1, and the position of the stapler in use is fixed.

A staple bending plate 13 is attached approximately in the center of the upper surface of the base 1 so that it is situated under the staple stamping plate 7. Two types of staple bending parts 13A, 13B are provided in this staple bending plate 13. The direction of the staple bending plate 13 is changed according to the kind of staple used, either the staple bending part 13A or 13B (the staple bending part 13A or 13B on the right-hand side of FIG. 1 and FIG. 2) being selected for staple bending immediately under the staple stamping plate 7.

At the rear of the staple bending plate 13 (right-hand side of FIG. 1 and FIG. 2), a long hole 14 extending in front of the frame 4 is formed in the longitudinal direction of the base. A positioning member (hereafter referred to as a first member) 20 is attached in this long hole 14 such that it is free to slide along the long hole 14. Plural female parts 15A, 15B are formed at a predetermined spacing on both sides of the long hole 14, respectively.

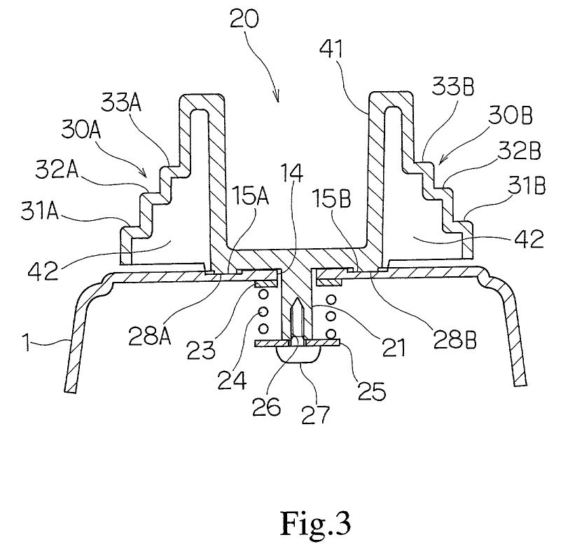

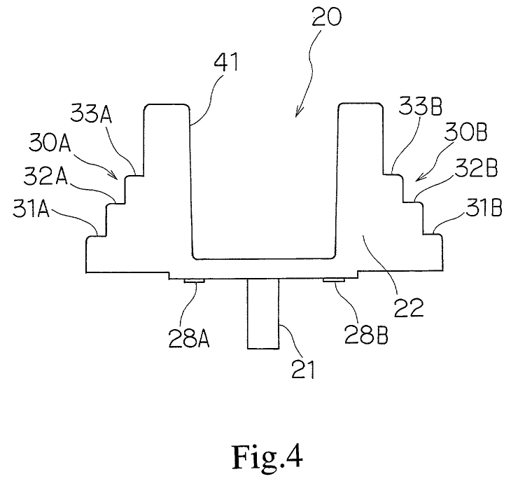

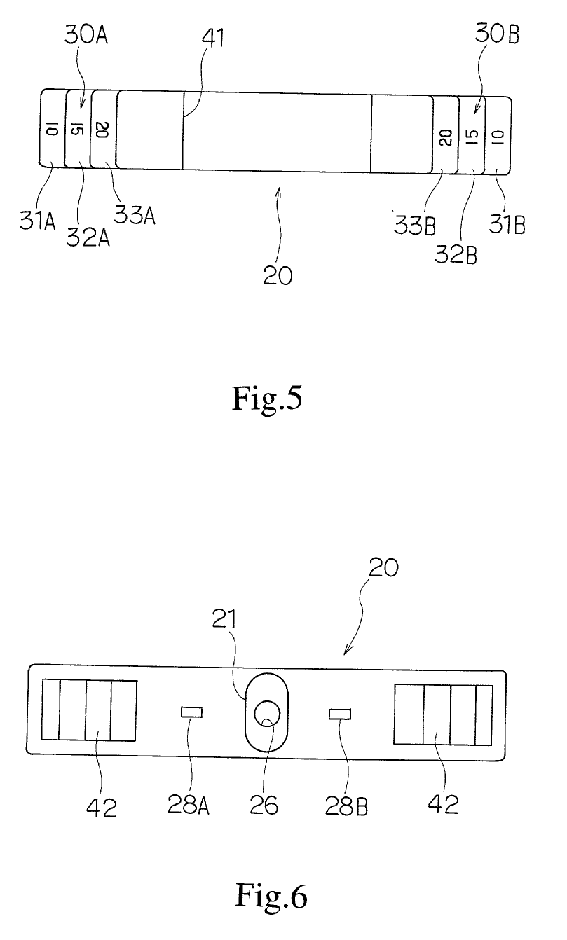

As shown in FIG. 3 - FIG. 6, the first member 20 has step parts 30A, 30B on both sides of a U-shaped body part 41. The first member 20 is provided with a shaft part 21 extending downwards from its lower end side. The first member 20 is set so that the staple case 2 is sandwiched by the body part 41. The bundle of paper is positioned when the edge of the bundle of paper contacts a front part 22 which is oriented towards the side of the stamping plate 13.

The shaft part 21 of the first member 20 fits into the long hole 14. In this fitting state, an upper ring 23, a spring 24 and a lower ring 25 are disposed sequentially on the circumference of the shaft part 21 from the underside of the base 1. The lower ring 25 is fixed to the end of the shaft part 21 by screwing a screw 27 into a hole 26 formed coaxially with the long hole 21. Due to this construction, the first member 20 is permanently pushed against the base 1 by the spring force of the spring 24 sandwiched between the upper ring 23 and the bottom ring 25.

A pair of male parts 28A, 28B for positioning are formed on both sides of the shaft part 21 of the first member 20. These male parts 28A, 28B fit into the female parts 15A, 15B of the base 1, respectively, so that the motion of the first member 20 can be adjusted in the front-back direction (longitudinal direction of the long hole 14). Hence, the first member 20 can be set in a desired position by selecting the female parts 15A, 15B for positioning into which the male parts 28A, 28B fit. When it is desired to change the position of the first member 20 in the front-back direction, if the first member 20 is pushed forwards and backwards, the first member 20 floats up slightly against the spring force of the spring 34, the male parts 28A, 28B separate from the female parts 15A, 15B, and the first member 20 can then be moved forward and backward.

Step-like parts 30A, 30B are formed symmetrically to the left and right on both sides of the first member 20. These step parts 30A, 30B both have three steps, and are respectively provided with three upward-facing steps 31A, 32A, 33A and 31B, 32B and 33B.

The height of each step is marked on the steps 31A to 33A and 31B to 33B, respectively. Specifically, the numeral “10” which shows that the height is 10 mm is marked on the steps 31A, 31B, the numeral “15” which shows that the height is 15 mm is marked on the steps 32A, 32B and the numeral “20” which shows that the height is 20 mm is marked on the steps 33A, 33B.

The marking on the steps 31A-33A, 31B-33B need only correspond to the height of the step, and is not necessarily the actual height of the step. For example, the kind of staple corresponding to the height may be shown.

The markings on the steps 31A-33A, 31B-33B can also be Braille points.

From the body part 41 of the first member 20 to the step parts 30A, 30B, the inside is a hollow part 42.

The first member 20 is made of resin, and is manufactured by mold forming, etc.

The operation of the device will now be described.

When a binding operation is performed with the stapler, the first member 20 is set to a suitable position, and the bundle of paper is set on the base 1 so that the edge of the bundle is in contact with the front part 22 of the first member 20.

In this case, the bundle of paper is in contact with the front part 22 of the first member 20, and since it is adjacent to the step parts 30A, 30B of the first member 20, the height can easily be visually compared with the steps 31A-33A and 31B-33B of the step parts 30A, 30B. Therefore, based on a comparison of the thickness of the bundle of paper and the height of the steps, the user of the stapler can determine the thickness of the bundle of paper exactly, and can choose the staple corresponding to the thickness of the bundle of paper correctly.

Moreover, as markings corresponding to the height of the step are respectively displayed on the steps 31A-33A and 31B-33B, the user of the stapler can determine the height of each step at a glance based on this display, and can easily judge the thickness of the bundle of paper based on a comparison with the height of the step. Therefore, a suitable staple according to the thickness of the bundle of paper can be selected still more easily and correctly.

In this case, as the steps 31A-33A and 31B-33B are upward-facing surfaces, even when the bundle of paper is brought in contact with the first member 20 and set, the display on the steps 31A-33A and 31B-33B is not hidden by the bundle of paper, and can always be easily seen from above during operation.

The steps 31A-33A and 31B-33B are effectively flat upward-facing surfaces, so the marking can be easily made (for example, by stamping).

Moreover, as the step parts 30A, 30B are formed in the side parts of the first member 20 and the markings are provided on the upward-facing steps 31A-33A and 31B-33B, the first member 20 may be used in the same way whether the front face or the rear face of the first member 20 is used as the surface (front part 22) in contact with the bundle of paper. Therefore, it is not necessary to be concerned about which is the front or rear of the first member 20 during installation of the first member 20 on the base 1, and installation is easy.

Moreover, as the shape of the step parts 30A, 30B is simple, it is easy to appreciate the shape also by touching the step with the finger. Therefore, the height of the bundle of paper can easily be compared with the steps 31A-33A and 31B-33B by touching the first member 20, so the thickness of the bundle of paper may be determined and the exact staple selected even by a visually handicapped user, for example. In this case, if the markings on the steps 31A-33A and 31B-33B are Braille points, a visually handicapped user can use the stapler even more easily.

Also, if the user holds the stapler, as the step parts 30A, 30B are easy to hold, the step parts 30A, 30B do not interfere with the operation of the first member 20.

Moreover, as the step parts 30A, 30B are formed on both sides of the first member 20, the thickness of the bundle of paper can be judged at a glance by comparison with the step parts 30A, 30B whether viewed from the left or right of the stapler (whether viewed from the side or the rear shown in FIG. 1).

Moreover, since the hollow part 42 is formed inside the first member 20, although the step parts 30A, 30B are provided for determining the thickness of the bundle of paper, the materials required for forming the first member 20 can be reduced, and cost reduction is achieved.

As the first member 20 has a simple shape comprising only the step parts 30A, 30B, it is easy to carry out mold forming, and it is easy to manufacture.

In the above embodiment, although the step parts 30A, 30B were formed symmetrically on the both sides of the first member 20, this invention is not limited to such a form. For example, the step parts may be provided only on one side. Moreover, when the step parts are provided on both sides of the first member 20, the left and right step parts may have different shapes.

What is claimed:

1. A stapler provided with a positioning member in contact with a binding object which specifies the position of the binding object, comprising a step part on at least one side face of the positioning member, wherein it is possible to determine the height of the binding object by comparison of the height of each steps of this step part with the height of the binding object.

2. A stapler as defined in claim 1, wherein a marking is made corresponding to the height of the step on each step of the step part.

3. A stapler as defined in claim 1 or 2, wherein the step part is provided on both sides of the positioning member.

4. A stapler as defined in any of claim 1 to claim 3, wherein a hollow part is formed in the positioning member.

5. A stapler positioning member in contact with a binding object which specifies the position of the binding object, comprising a step part on at least one side face, wherein it is possible to determine the height of the binding object by comparison of the height of each steps of this step part with the height of the binding object.

6. A stapler positioning member as defined in claim 5, wherein a marking is made corresponding to the height of the step on each step of the step part.

7. A stapler positioning member as defined in claim 5 or 6, wherein the step part is provided on both sides.

8. A positioning member as defined in any of claim 5 to claim 6, wherein a hollow part is formed therein.
